(19) United States
(12) Patent Application Publication
(10) Pub. No.: US 2005/0223647 A1
(43) Pub. Date: Oct. 13, 2005

(54) Garage door seal

(76) Inventors: Ellis D. Stutzman, Westminster, CO (US); David R. West, Choctaw, OK (US)

Correspondence Address: ANCEL W. LEWIS, JR., 425 WEST MULBERRY, SUITE 101, FORT COLLINS, CO, 80521, US

(21) Appl. No.: 10/822,399

(22) Filed: Apr. 12, 2004

(51) Int. Cl. E06B 7/22

(52) U.S. Cl. 49/499.1

(57) ABSTRACT

A seal particularly suitable for the bottom of a garage door has a rigid base portion made of a plastic material that is fastened to the bottom of the garage door and a flexible U-shaped seal portion made of a plastic material that is integral with and preferably coextruded with the base portion. An attachment area is provided on the base portion for fastening to the garage door and a side section on the base portion is provided for locating the seal relative to the garage door. The seal can be attached after the garage door sections have been banded for shipping and storage, preventing distortion of the seal portion.

### TECHNICAL FIELD

This invention relates to seals that mount on the frame of a door to form a seal between the frame and door and more particularly to a plastic door seal that is particularly suitable for sealing the bottom of an overhead garage door.

### BACKGROUND ART

The bottom of a conventional garage door is generally provided with a bottom seal. A simple garage door bottom seal includes a base attached to the bottom of the garage door and a flexible flap that extends downwardly and outwardly from the base. An improved garage door bottom seal has a rigid base portion attached to the bottom of the garage door and a downwardly extending, U-shaped, flexible seal portion attached to the base. The seal has a two piece construction and is tailored for garage doors with tongue and groove sections with the base portion having a projection that fits into the groove in the bottom of the garage door. The base portion is fastened to the garage door with fasteners through the projection and into the garage door section at the groove.

The base portion has two spaced, downwardly opening, T shaped channels. The seal portion has T shaped sections along opposite ends that fit into the channels. After the base portion is fastened to the garage door, the seal portion can be assembled to the base portion by sliding the T shaped sections into the channels. Assembly of this type of two piece prior known seal is time consuming and labor intensive.

U.S. Pat. No. 5,396,735 to Dietrich discloses a garage door bottom seal with a U-shaped, flexible seal portion, having such a two piece construction. The seal of Dietrich is specifically tailored for garage doors with tongue and groove sections, and is not suitable for garage doors with flat edges or shiplap sections. U.S. Pat. No. 4,447,989 to Mailand et al. discloses a one piece, coextruded weather-strip for swinging doors with a pair of rigid portions connected by a resilient portion. The weather-strip disclosed by Mailand et al. has a two step assembly process and mounts on the side of a door with the rigid portions vertical.

Garage door sections are often banded for shipping and storage. Known garage door bottom seals with a U-shaped, flexible seal portion cannot be installed over the bands, and are installed before banding. The bands over the garage door bottom seal often permanently distort the seal, so that the seal must be replaced. A one piece garage door bottom seal that can be installed after banding that can be installed in a single step and that is suitable for flat, and tongue and groove garage door sections is desirable.

### DISCLOSURE OF THE INVENTION

A door seal particularly suitable for mounting on the bottom of a garage door includes a rigid base portion and a flexible seal portion. The base portion is L-shaped having a bottom section that mounts along the bottom of a garage door and a side section that extends upwardly from the bottom section along a side of the garage door. The seal portion is U-shaped and extends downwardly from the base portion with spaced opposite ends attached to the base portion. The base portion and flexible portion preferably are coextruded with the base portion providing rigidity and the seal portion being flexible to compress between the garage door bottom and a garage floor to provide a seal when the garage door is closed.

### BRIEF DESCRIPTION OF THE DRAWINGS

Details of this invention are described in connection with the accompanying drawings that bear similar reference numerals in which:

FIG. 1 is a front elevation view of the bottom panel of a garage door with a garage door seal embodying features of the present invention.

FIG. 2 is a sectional view along line 2-2 of FIG. 1.

FIG. 3 is a sectional view along line 2-2 of FIG. 1 with the garage door open.

FIG. 4 is a partial end view of banded garage sections with the seal of FIG. 3.

### DETAILED DESCRIPTION OF THE INVENTION

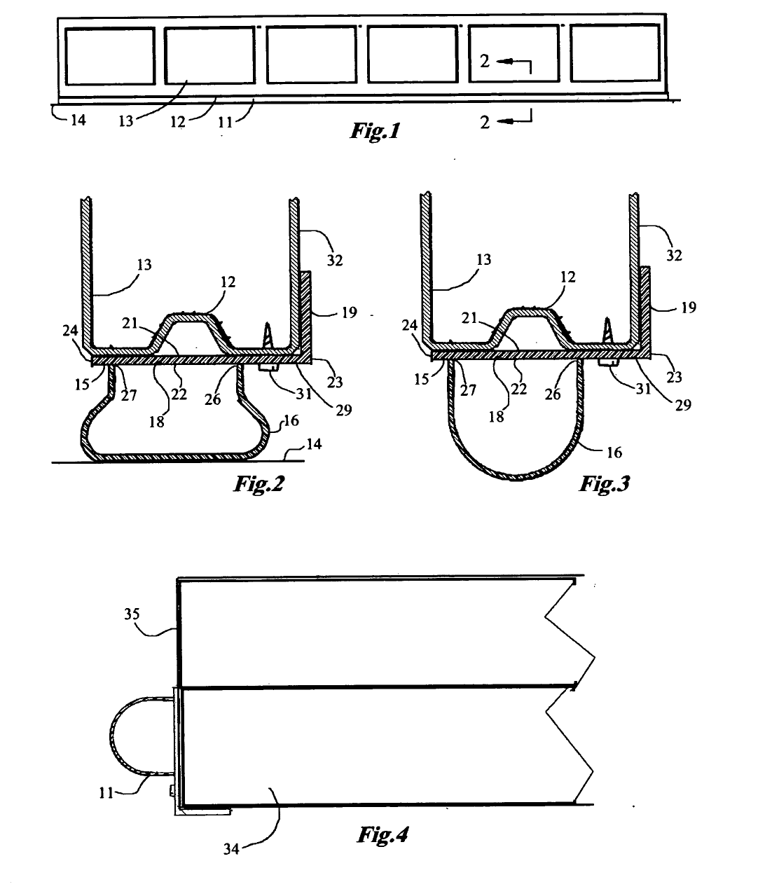

Referring now to FIGS. 1, 2 and 3, a garage door seal 11 embodying features of the present invention mounts along the bottom 12 of a garage door 13, and includes a base portion 15 and a seal portion 16. The base portion 15 is substantially L-shaped with a bottom section 18 and a side section 19. The bottom section 18 has a flat upper surface 21 and a spaced lower surface 22, opposite the upper surface 21. The width of the upper surface 21 is sized to be approximately the thickness of the garage door 13. Spaced first and second base ends 23 and 24 extend between the upper surface 21 and the lower surface 22. The side section 19 connects to the bottom section 18 at the first base end 23 and extends upwardly therefrom. Preferably the base portion 15 is rigid and particularly made of rigid extruded plastic.

The seal portion 16 is flexible and, if laid flat, would have an elongated rectangular shape with long, spaced first and second seal ends 26 and 27. The first seal end 26 is secured to the lower surface 22 of the bottom section 18 of the base portion 15, and is parallel and spaced inward from the first base end 23 to form an attachment area 29 on the bottom section 18 between the first base end 23 and the first seal end 26. The second seal end is secured to the lower surface 22 of the bottom section 18 of the base portion 15 near the second base end 24.

Preferably the seal portion 16 is made of flexible extruded plastic. A preferred method of manufacture is to coextrude the base portion 15 and seal portion 16 so they become a unitary or integral body. By way of example, and not as a limitation, the seal 11 may be made of a vinyl material such as polyvinyl chloride, and the seal portion 16 may have a hardness of about 62 durometer. As shown in FIG. 2, the seal portion 16 flexes and deforms, bulging out, when the garage door 13 is closed, to seal between the bottom 12 of the garage door 13 and the garage floor 14.

The seal 11 is assembled to the garage door 13 with the upper surface 21 of the bottom section 18 of the base 15 positioned on the bottom 12 of a garage door 13, and the side section 19 preferably positioned on the inside surface 32 of the garage door 13. The seal 11 is attached to the garage door 13 with fasteners 31, such as screws, nails or staples, that extend through the attachment area 29 and into the garage door 13.

FIG. 4 shows garage door sections 34 banded with bands 35. The flat upper surface 21 of the bottom section 18 of the base portion 15 permits the seal 11 to be assembled to the bottom 12 after the garage door sections 34 are banded, preventing distortion of the seal 11 during storage and shipping. The flat upper surface 21 of the bottom section 18 of the base portion 15 also permits the seal 11 to be assembled to flat, and tongue and groove garage doors. Locating the attachment area 29 between the first base end 23 and the first seal end 26 further facilitates mounting the seal 11 to flat, and tongue and groove garage doors. The one piece construction of the seal 11 reduces the labor and time to attach the seal 11 relative to prior known seals. The seal 11 can be assembled in a single step. The side section 19 of the base portion 15 helps locate the seal 11 relative to the bottom 12 of the garage door 13.

Although the present invention has been described with a certain degree of particularity, it is understood that the present disclosure has been made by way of example and that changes in details of structure may be made without departing from the spirit thereof.

1. A one piece door seal for sealing a gap between a garage door having a bottom and an inside surface, and a garage floor, comprising:
a base portion having a horizontally extending bottom section with a flat upper surface for mounting against said bottom of said garage door, a spaced lower surface, opposite said upper surface, and spaced first and second base ends, said base portion being made of a rigid first compound of a plastic material and extruded, and
a U-shaped seal portion having spaced, parallel first and second seal ends secured to said lower surface, said seal portion being made of a flexible second compound of said plastic material and coextruded with said base portion to form an integral unit with said base portion, whereby said seal portion deforms to seal between said bottom of said garage door and said garage floor when said garage door is closed.

2. The seal as set forth in claim 1 wherein said first seal end is spaced inwardly from said first base end to form an attachment area for receiving fasteners that extend through said bottom section of said base portion in said attachment area and into said bottom of said garage door to attach said base to said garage door, and
said second seal end is secured near said second base end.

3. The seal as set forth in claim 1 wherein said base portion has a side section for placement against said inside surface to locate said base relative to said bottom, said side section extending upwardly from said first base end of said bottom section.

4. The seal as set forth in claim 1 wherein said plastic material is a vinyl material.

5. The seal as set forth in claim 4 wherein said vinyl material is polyvinyl chloride.

6. The seal as set forth in claim 1 wherein said seal portion has a hardness of about 62 durometer.

7. A one piece door seal for sealing a gap between a garage door having a bottom and an inside surface, and a garage floor, comprising:
a base portion including a horizontally extending bottom section and a side section, said bottom section having a flat upper surface for mounting against said bottom of said garage door, a spaced lower surface, opposite said upper surface, and spaced first and second base ends, said side portion extending upwardly from said first base end for placement against said inside surface to locate said base relative to said bottom, said base portion being made of a rigid first compound of a plastic material and extruded, and
a U-shaped seal portion having spaced, parallel first and second seal ends secured to said lower surface, said first seal end being spaced inwardly from said first base end to form an attachment area for receiving fasteners that extend through said bottom section of said base portion in said attachment area and into said bottom of said garage door to attach said base to said garage door, said second seal end being secured near said second base end, said seal portion being made of a flexible second compound of said plastic material and coextruded with said base portion to form an integral unit with said base portion, whereby said seal portion deforms to seal between said bottom of said garage door and said garage floor when said garage door is closed.
